(19) United States
(12) Patent Application Publication
(10) Pub. No.: US 2026/0079862 A1
(43) Pub. Date: Mar. 19, 2026

(54) SYSTEM ON CHIP AND COMPUTING DEVICE INCLUDING THE SAME

(71) Applicant: Samsung Electronics Co., Ltd., Suwon-si (KR)

(72) Inventors: Jungrae KIM, Suwon-si (KR); Soyoung PARK, Suwon-si (KR); Junseung LEE, Suwon-si (KR)

(73) Assignees: Samsung Electronics Co., Ltd., Suwon-si, Gyeonggi-do (KR); RESEARCH & BUSINESS FOUNDATION SUNGKYUNKWAN UNIVERSITY, Gyeonggi-do (KR)

(21) Appl. No.: 19/313,141

(22) Filed: Aug. 28, 2025

(30) Foreign Application Priority Data
Sep. 13, 2024 (KR) 10-2024-0126185

(51) Int. Cl. G06F 13/16; G06F 11/10; G06F 15/78

(52) U.S. Cl. CPC G06F 13/1668; G06F 11/1064; G06F 15/7807; G06F 2213/0038

(57) ABSTRACT

Provided are system on chips (SoC) and a computing devices including the SoC. The SoC may be configured to control an external main memory, and may include a memory controller configured to generate B-byte parity for A-byte data and detect an error in the A-byte data using the B-byte parity, wherein A and B are natural numbers, store the A-byte data and the B-byte parity to one memory block of the external main memory by transmitting a write command to the external main memory and the A-byte data and the B-byte parity to the external main memory and read the A-byte data and the B-byte parity from the one memory block of the external main memory by transmitting a read command to the external main memory, a data cache memory configured to transmit the A-byte data to and receive the A-byte data from the memory controller and cache the A-byte data, and a processor configured to access the external main memory.

### CROSS-REFERENCE TO RELATED APPLICATION

This application is based on and claims priority under 35 U.S.C. § 119 to Korean Patent Application No. 10-2024-0126185, filed on Sep. 13, 2024, in the Korean Intellectual Property Office, the disclosure of which is incorporated by reference herein in its entirety.

### BACKGROUND

The inventive concepts relates to system on chips for access to main memory, and more particularly, to system on chips for access to in-band memory and computing devices including the system on chip.

System on chips (SoCs) may have access to memory to perform data processing. When writing data to or reading data from memory, an SoC may use parity information to check for possible errors in the data. For example, an SoC may use 8 bytes of parity information for each 64 bytes of data to check for data errors that occur when writing or reading the data and, in some cases, directly correct the erroneous data.

The increase in bandwidth that occurs when the SoC accesses the memory may increase the power consumption of the SoC. Therefore, when the SoC accesses the memory, it is beneficial to use bandwidth more efficiently.

### SUMMARY

The inventive concepts provide main memory that stores data and parity together in one block. This allows data and parity to be written or read all together via a single command rather than separate commands during a write or read operation, thus reducing the delay time in accessing the main memory.

According to some aspects of the inventive concepts, there is provided a system on chip (SoC) configured to control external main memory, the SoC including a memory controller configured to generate B-byte parity for A-byte data and detect an error in the A-byte data using the B-byte parity, wherein A and B are natural numbers, store the A-byte data and the B-byte parity to one memory block of the external main memory by transmitting a write command to the external main memory and the A-byte data and the B-byte parity to the external main memory and read the A-byte data and the B-byte parity from the one memory block of the external main memory by transmitting a read command to the external main memory, a data cache memory configured to transmit the A-byte data to and receive the A-byte data from the memory controller and cache the A-byte data, and a processor configured to access the external main memory.

According to some aspects of the inventive concepts, there is provided an SoC, the SoC including a memory controller configured to control a main memory, the main memory comprising a plurality of blocks, and each of the plurality of blocks configured to store A-byte data and B-byte parity together, wherein A and B are natural numbers, and generate the 8-byte parity and detect, based on the 8-byte parity, an error in the 56-byte data; and a data cache memory comprising a plurality of cache lines, and each of the plurality of cache lines is A bytes in size, and configured to transmit the A-byte data to and receive the A-byte data from the memory controller and cache the A-byte data.

According to some aspects of the inventive concepts, there is provided a computing device including a main memory, the main memory comprises a plurality of blocks, and each of the plurality of blocks stores A-byte data and B-byte parity together, and an SoC, the SoC includes a memory controller configured to generate the 8-byte parity for detecting an error in the 56-byte data and detect, based on the 8-byte parity, the error in the 56-byte data, a data cache memory comprising a plurality of cache lines, and each of the plurality of cache lines is A bytes in size, and configured to cache the A-byte data from the memory controller, and a processor configured to access the main memory.

### BRIEF DESCRIPTION OF THE DRAWINGS

Example embodiments will be more clearly understood from the following detailed description taken in conjunction with the accompanying drawings in which:

FIG. 1 is a schematic block diagram illustrating a computing device according to some example embodiments;

FIG. 2 is a specific block diagram illustrating a computing device according to some example embodiments;

FIG. 3 is a diagram illustrating an example structure of the main memory of FIG. 2;

FIG. 4 is a diagram illustrating a mapping operation between a memory controller and data cache memory, according to some example embodiments;

FIG. 5 is a block diagram illustrating a computing device performing a write operation, according to some example embodiments;

FIG. 6 is a flowchart illustrating an operation method of the computing device performing a write operation, according to some example embodiments;

FIG. 7 is a block diagram illustrating the computing device performing a read operation, according to some example embodiments;

FIG. 8 is a flowchart illustrating an operation method of the computing device performing a read operation, according to some example embodiments;

FIG. 9 is a block diagram illustrating a computing device according to some example embodiments; and

FIG. 10 is a block diagram illustrating an example configuration of an electronic system, according to some example embodiments.

### DETAILED DESCRIPTION OF THE EMBODIMENTS

Hereinafter, embodiments are described in detail with reference to the accompanying drawings.

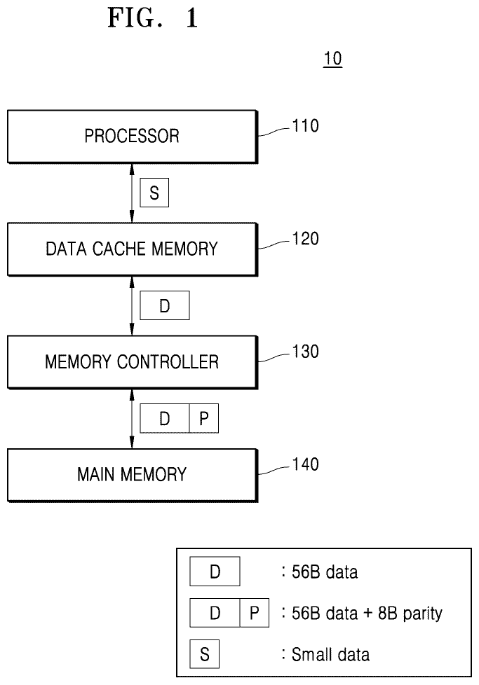

FIG. 1 is a schematic block diagram illustrating a computing device 10 according to some example embodiments.

Referring to FIG. 1, the computing device 10 may include a processor 110, data cache 120 for data (hereinafter, referred to as data cache memory 120), a memory controller 130, and main memory 140.

The computing device 10 according to some example embodiments may include a computer or a mobile device. In the computing device 10, data may be stored and/or written to the main memory 140, and/or data may be read from the main memory 140.

The computing device 10 may use parity information to check the data for errors. The computing device 10 according to some example embodiments may generate a specific size of parity for each specific size of data. For example, the computing device 10 may utilize the 8-byte parity for the 56-byte data. For example, the computing device 10 may utilize the 8-byte parity for the 64-byte data.

Hereinafter, for convenience of description, it is assumed and described that the computing device 10 according to some example embodiments utilizes the 8-byte parity for the 56-byte data to protect data. However, example embodiments are not limited thereto, and other sized data may be used.

The computing device 10 may include a system on chip (SoC) and the main memory 140. For example, the SoC may include the processor 110, the data cache memory 120, and the memory controller 130. For example, in the case of a mobile device, an SoC including a memory controller 130 may communicate with the main memory 140 on the outside.

The processor 110 may control all operations of the computing device 10 and perform logical computations. The processor 110 according to some example embodiments may be configured as an SoC. The processor 110 according to some example embodiments may include an application specific integrated circuit (ASIC), an embedded processor, a microprocessor, hardware control logic, a hardware finite state machine (FSM), a digital signal processor (DSP), or a combination thereof.

The processor 110 according to the embodiment may communicate with the data cache memory 120 for managing data. For example, the processor 110 may transmit small data to the data cache memory 120 to perform a write operation of 8 bytes of small data. Also, the processor 110 may receive small data from the data cache memory 120 to perform a read operation of 8 bytes of small data.

The data cache memory 120 may store small data S received from the processor 110. According to some example embodiments, caching may represent copying and moving data from the main memory 140 to the data cache memory 120, and storing may represent writing the small data S received from the processor 110 to the cached space inside the data cache memory 120. The data cache memory 120 includes memory that temporarily and partially stores the data stored in the main memory 140 and enables quick access to the data that has been used in the main memory 140.

The data cache memory 120 according to some example embodiments may cache, in units of cache lines, data stored in the main memory 140. For example, a cache line in the data cache memory 120 may be 56 bytes in size, and a cache line in the main memory 140 may be 64 bytes in size. The data cache memory 120 may cache data from the memory controller 130 in units of 56-byte cache lines. The data cache memory 120 may have tag information indicating which region of data in the main memory 140 is being cached and may have tag information for each cache line.

The data cache memory 120 may output data to or input data from the memory controller 130. For example, in the case of a write operation, the data cache memory 120 may store the small data S received from the processor 110, change the stored small data S to a 56-byte size, and output the changed small data S to the memory controller 130.

For example, when the processor 110 makes a write request, the data cache memory 120 may output, to an error correction code (ECC) engine 131, the 8-byte size of small data S received from the processor 110 and the 56-byte size of data stored in the data cache memory 120. For example, when the processor 110 makes a read request, if the requested data is present in the data cache memory 120, the data cache memory 120 may output the requested 8-byte size of small data S to the processor 110.

The main memory 140 may store the data and parity. The main memory 140 may be used as the operating memory of the computing device 10. The main memory 140 may store data and parity for checking the data for errors. This main memory 140 may be provided as volatile memory according to standards, such as dynamic random-access memory (DRAM). Specifically, for example, the main memory 140 may include volatile memory, such as synchronous DRAM (SDRAM), double data rate SDRAM (DDR SDRAM), low power double data rate SDRAM (LPDDR SDRAM), graphics double data rate SDRAM (GDDR SDRAM), DDR2 SDRAM, DDR3 SDRAM, DDR4 SDRAM, DDR5 SDRAM, low power double data rate 4th generation (LPDDR4) DRAM, and low power double data rate 5th generation (LPDDR5) DRAM. However, example embodiments are not limited thereto.

The main memory 140 according to some example embodiments may use the same memory bus to transmit or receive the data and parity. For example, the main memory 140 may transmit the data and parity to and receive the data and parity from the outside via a single channel.

The main memory 140 may use a specific format when transmitting the data and parity to and receiving the data and parity from the outside. For example, the data input to or output from the main memory 140 may be 56 bytes in size, and the parity input to or output from the main memory 140 may be 8 bytes in size. That is, the default size unit for data and parity input to or output from the main memory 140 may be 64 bytes in size. Hereinafter, the reference size may represent the default size unit utilized by the main memory 140 for transmitting and receiving the data and parity. When data and parity are stored in the same memory, such as the main memory 140, and the memory uses the same memory bus to transmit and receive the data and parity, such memory may be referred to as in-band memory.

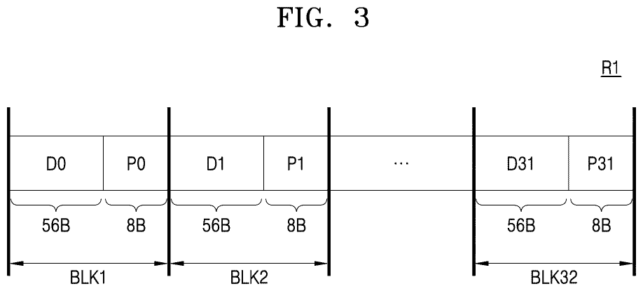

Hereinafter, for convenience of description, it is assumed that the main memory 140 has a reference size of 64 bytes, and transmits the 56-byte data and 8-byte parity to and receives the 56-byte data and 8-byte parity from the outside. For example, the main memory 140 may have a memory bandwidth of 64 bytes. A specific description of the configuration in which the main memory 140 stores the data and parity is described in detail with reference to FIG. 3.

As used herein, the small data may represent data to be written or read by the processor 110, which is smaller in size (e.g., 8 bytes) than the 54-byte data used by the main memory 140.

The memory controller 130 may generate parity to check the data for errors. The memory controller 130 may receive the data and parity and may check the received data for errors on the basis of the parity. The memory controller 130 may utilize the data to generate parity for checking for errors in the data.

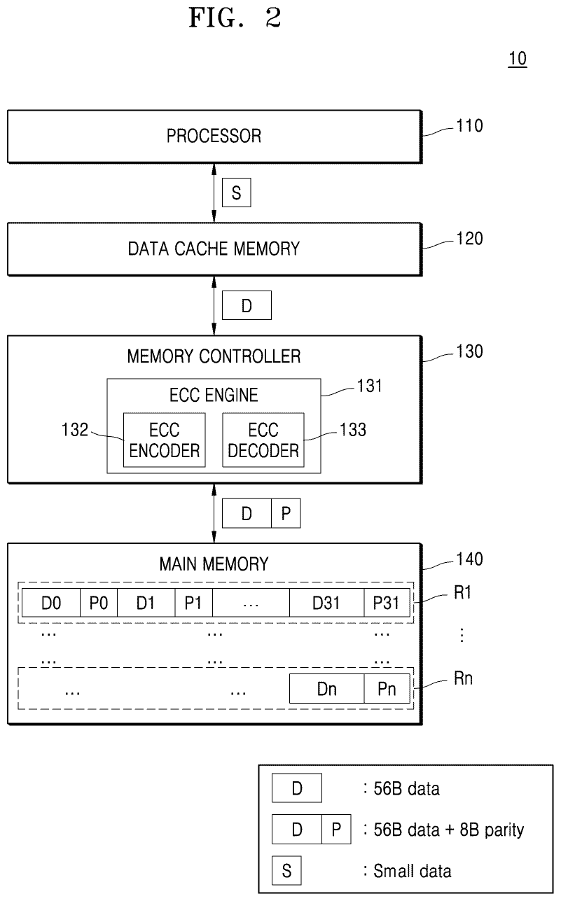

The memory controller 130 may read the data and parity from the main memory 140 and then, based on the parity, check the read data for errors. The operation of generating the parity for data to be written to the main memory 140 or checking the data read from the main memory 140 for errors on the basis of the parity may be performed by the ECC engine 131 in FIG. 2. A more detailed configuration of the memory controller 130 according to some example embodiments is described below with reference to FIG. 2.

For example, the memory controller 130 may generate and provide the 8-byte parity to the main memory 140 on the basis of the 56-byte data received from the data cache memory 120. For example, the memory controller 130 may read the 56-byte data and 8-byte parity received from the main memory 140, and then check the read 56-byte data for errors on the basis of the 8-byte parity.

The memory controller 130 may control all operations of the main memory 140. For example, the memory controller 130 may control the main memory 140 to write data or read data in response to a request from the outside (e.g., a host). The memory controller 130 may communicate with the outside via a variety of standard interfaces. In some example embodiments, the memory controller 130 may issue commands and addresses for controlling the operations of the main memory 140. Here, the command may include, for example, a read command, a write command, or the like.

FIG. 2 is a specific block diagram illustrating a computing device 10 according to some example embodiments. In the following descriptions, repeated descriptions as those given with reference to FIG. 1 are omitted.

Referring to FIG. 2, the computing device 10 may include a processor 110, data cache memory 120, a memory controller 130, and main memory 140.

The difference between FIG. 1 and FIG. 2 is that the memory controller 130 in FIG. 2 may further include an ECC engine 131, and the ECC engine 131 may further include an ECC encoder 132 and an ECC decoder 133. Also, the main memory 140 of FIG. 2 may include a plurality of blocks BLK1 to BLK32 (FIG. 3) corresponding to a plurality of rows R1 to Rn. However, some or all of the features of FIG. 2 may be present and/or included in FIG. 1.

The ECC engine 131 may read the data and parity from the main memory 140 and then, based on the parity, check the read data for errors. The ECC engine 131 may generate parity for data to be written to the main memory 140 or may check data read from the main memory 140 for errors on the basis of the parity.

The ECC encoder 132 may utilize data D to generate parity P. For example, the ECC encoder 132 may encode data on the basis of 56 bytes of data D (hereinafter, 56-byte data D) to generate 8 bytes of parity P (8-byte parity P). For example, in a write operation, the ECC encoder 132 may encode 56-byte data D to generate 8-byte parity P and may provide the 56-byte data D and the 8-byte parity P together to the main memory 140.

The ECC decoder 133 may utilize the parity P to detect or correct errors in the data D. For example, the ECC decoder 133 may utilize the 56-byte data D and the 8-byte parity P received from the main memory 140 to detect or correct errors in the data D, and output only the error-corrected 56-byte data D. For example, in a read operation, the ECC decoder 133 may decode the 56-byte data D and the 8-byte parity P and provide only 56-byte data D to the data cache memory 120.

The main memory 140 may include a plurality of rows R1 to Rn, and one row may include a plurality of blocks. Each block may contain both data and parity. For example, the main memory 140 may include n rows (where n is a natural number). The main memory 140 may include 56-byte data D and 8-byte parity P per block. For example, an nth block may contain nth data Dn having a size of 56 bytes and nth parity Pn having a size of 8 bytes.

For example, when the main memory 140 is 2K bytes in size, one row may contain 32 blocks, each having a size of 64 bytes. However, example embodiments are not limited thereto. The structure of the main memory 140 is described below in detail with reference to FIG. 3.

FIG. 3 is a diagram illustrating an example structure of the main memory 140 of FIG. 2.

Referring to FIG. 3, a first row R1 may include a plurality of blocks, and one block may include data and parity. Each block may be 64 bytes in size. For example, a first block BLK1 may include first data D0 having a size of 56 bytes and first parity P0 having a size of 8 bytes, a second block BLK2 may include second data D1 having a size of 56 bytes and a second parity P1 having a size of 8 bytes, and a thirty-second block BLK32 may include thirty-second data D31 having a size of 56 bytes and thirty-second parity P31 having a size of 8 bytes.

As shown in FIG. 3, for example, when the main memory 140 is 2K bytes in size, the first row R1 may include 32 blocks, each having a size of 64 bytes. However, example embodiments are not limited thereto, and the first row R1 may include 16 blocks, each having a size of 64 bytes.

According to a comparative example, a region for storing data and a region for storing parity may be provided separately from each other in a main memory. In other words, in main memory, the region for storing data may contain data blocks, and the region for storing parity may contain parity blocks. When the region for storing data and the region for storing parity are configured separately, it is not convenient to write or read the data and parity separately during write or read operations. Therefore, the delay time in accessing the main memory increases.

However, in the main memory 140 according to the embodiment, the data and parity may be stored all together in one block and thus simultaneously (e.g., at a same time, or about a same time such that, for example, subsequent actions are not impacted by any difference in timing) written or read during write or read operations. Accordingly, the delay time in accessing the main memory 140 may be reduced. In addition, for example, the memory controller 130 may write the data D and parity P of the main memory 140 together or read the data D and parity P together via a single command. For example, according to some example embodiments, there may be an increase in reliability, operating parameters (e.g., temperature resilience), speed, accuracy, and/or power efficiency of the memory device based on the above methods. Therefore, the improved devices and methods overcome the deficiencies of the conventional devices and methods while reducing resource consumption, and/or improving data accuracy, operating parameters, and resource allocation (e.g., latency).

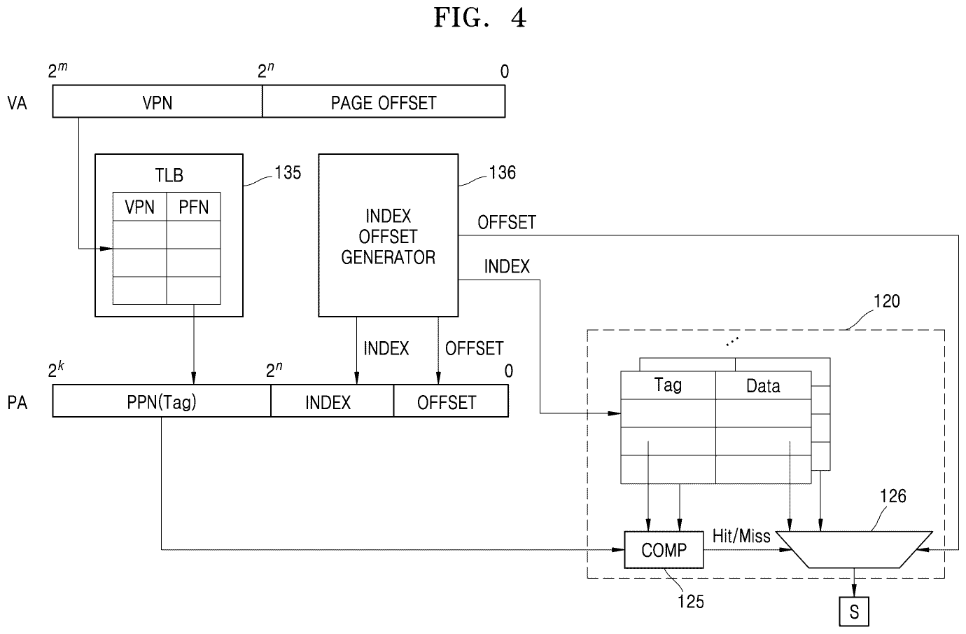

FIG. 4 is a diagram illustrating a mapping operation between a memory controller 130 and data cache memory 120, according to some example embodiments.

Referring to FIG. 4, the memory controller 130 may utilize an address conversion scheme to transmit 56-byte data B to the data cache memory 120. For example, the address conversion scheme according to some example embodiments may use a within-page index generation method and a virtual indexed physical tagged (VIPT) method.

The address conversion scheme according to some example embodiments may generate a virtual address VA for the 56-byte data D and convert the virtual address VA to a physical address PA.

The virtual address VA may include a virtual page number field VPN and a page offset field Page Offset. The physical address PA may contain a tag field Tag, an index field Index, and an offset field Offset.

The within-page index generation method may involve generating the index field Index and the offset field Offset in the physical address PA on the basis of the page offset field Page Offset in the virtual address VA. For example, the page offset field Page Offset may be converted to the index field Index and the offset field Offset via an index/offset generator 136. The index/offset generator 136 may receive an input of the page offset field Page Offset and generate the index field Index and the offset field Offset. The index/offset generator 136 may be provided in software as well as hardware.

The VIPT method may involve converting the virtual page number field VPN in the virtual address VA to the tag field Tag in the physical address PA. For example, the virtual page number field VPN may be converted into the tag field Tag using a translation lookaside buffer (TLB) 135. The TLB 135 may include a table that contains the virtual page number field VPN and a page frame number field PFN corresponding thereto. For example, when the virtual page number field VPN is input to the TLB 135, the page frame number field PFN corresponding thereto may be output to generate the tag field Tag of the physical address PA. The TLB 135 may be provided in software as well as hardware.

The page offset field Page Offset of the virtual address VA may be 2ⁿ bytes in size, and the virtual page number field VPN may be 2^{m}−2ⁿ bytes in size. Here, n and m are both natural numbers, and m may be any natural number greater than n. For example, when n is 11 and m is 56, the page offset field Page Offset may be 2¹¹ bytes in size, and the virtual page number field VPN may be 2⁵⁶−2¹¹ bytes in size.

The sum of the index field Index and offset field Offset of the physical address PA may be 2ⁿ bytes in size, and the tag field Tag may be 2^{k}−2ⁿ bytes in size. Here, n and k are both natural numbers, and k may be any natural number greater than n. For example, when n is 11 and k is 47, the sum of the index field Index and offset field Offset may be 2¹¹ bytes in size, and the tag field Tag may be 2⁴⁷−2¹¹ bytes in size. For example, the sum of the sizes of the index field Index and offset field Offset of the physical address PA may be equal to the size of the page offset field Page Offset of the virtual address VA.

For example, the value of the index field Index of the physical address PA may be used to select one block from a plurality of blocks, and the value of the tag field Tag may be used to select one data block from a plurality of data blocks. In addition, the value of the offset field Offset may be used to enable access to one data block in units of bytes.

Referring back to FIG. 4, the data cache memory 120 may utilize a mapping operation. For example, the mapping operation may use set associative mapping.

The set associative mapping may include a data region for storing data, and the data region may include a plurality of groups. For example, the data cache memory 120 may include n groups Group 1 to Group n for storing data.

For example, the value of a tag Tag of 56-byte data may be stored in the data cache memory 120. The values of the tag field Tag of the physical address PA and the tags Tag of the n groups Group 1 to Group n may be input to a comparison circuit 125. The comparison circuit 125 may generate a hit signal Hit when the values in the tag field Tag and the tag Tag match and may generate a miss signal Miss when the values in the tag field Tag and the tag Tag do not match. The comparison circuit 125 may provide the hit signal Hit or the miss signal Miss to a multiplexer 126.

The multiplexer 126 may receive the hit signal Hit or the miss signal Miss and receive an offset Offset generated by the index/offset generator 136, and the multiplexer 126 may be provided with block data stored in the n groups Group 1 to Group n. For example, the multiplexer 126 may be provided with the hit signal Hit, the offset Offset, and the block data, and may generate small data S corresponding thereto and provide the small data S to the processor 110. For example, the multiplexer 126 may be provided with the miss signal Miss, the offset Offset, and the block data, and may generate small data S corresponding thereto and provide the small data S to the processor 110.

In the computing device 10 according to some example embodiments, when utilizing the within-page index generation method and the VIPT method, which are associated with the address conversion scheme, the data cache memory 120 may have improved access, and/or the delay time in accessing the data cache memory 120 may be reduced and/or improve operations thereof.

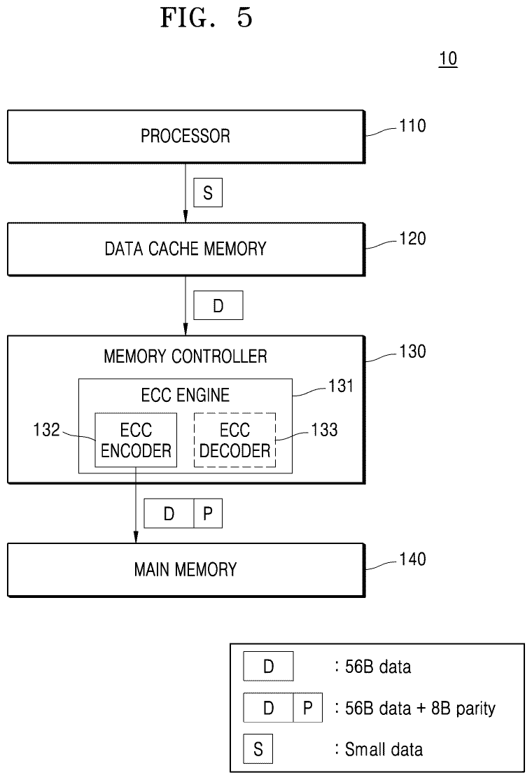

FIG. 5 is a block diagram illustrating a computing device 10 performing a write operation, according to some example embodiments. In the following descriptions, repeated descriptions as those given with reference to FIG. 2 are omitted.

Referring to FIG. 5, upon a write request, a processor 110 may provide 8-byte small data S to a data cache memory 120. The data cache memory 120 may convert the small data S and provide the 56-byte data D to a memory controller 130. An ECC encoder 132 of the memory controller 130 may generate 8-byte parity P on the basis of the received 56-byte data D. The memory controller 130 may provide the write command to the main memory 140 and simultaneously (e.g., at a same time, or about a same time such that, for example, subsequent actions are not impacted by any difference in timing) provide the 56-byte data D and the 8-byte parity P to the main memory 140. In the main memory 140, the 56-byte data D and the 8-byte parity may be written all together in one block. In other words, since the memory controller 130 may provide the 56-byte data D and the 8-byte parity P all together to the main memory 140 by using a single write command, the delay time in accessing the main memory 140 may be reduced.

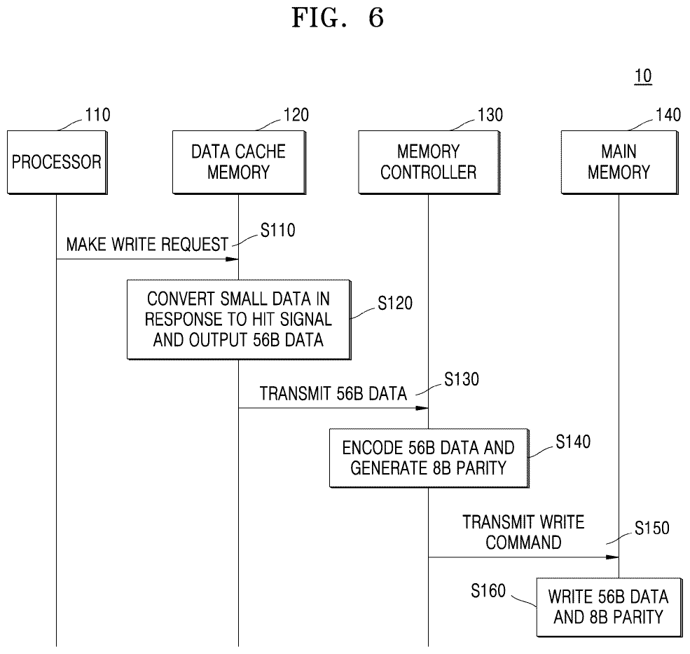

FIG. 6 is a flowchart illustrating an operation method of the computing device 10 performing a write operation, according to some example embodiments.

Referring to FIGS. 5 and 6 together, the processor 110 performs an operation of writing the 56-byte data and 8-byte parity to the main memory 140 using the data cache memory 120 and the memory controller 130.

Referring to FIG. 6, the processor 110 may request the data cache memory 120 to perform a write operation (S110). For example, the processor 110 may transmit the small data S to the data cache memory 120 while requesting a write operation.

In response to a hit signal Hit, the data cache memory 120 may convert the small data S and output the 56-byte data D (S120). For example, referring to FIG. 4,
The data cache memory 120 may transmit the converted 56-byte data D to the memory controller 130 (S130). For example, the data cache memory 120 may include a plurality of cache lines, and each of the plurality of cache lines may be 56 bytes in size.

The memory controller 130 may encode the 56-byte data D to generate the 8-byte parity P (S140). For example, the ECC encoder 132 may generate the 8-byte parity P on the basis of the received 56-byte data D.

The memory controller 130 may transmit a write command to the main memory 140 (S150). The main memory 140 may write the 56-byte data D and the 8-byte parity P together (S160). For example, since the main memory 140 may store the 56-byte data D and the 8-byte parity P all together in one block, the memory controller 130 may transmit a single write command to the main memory 140 and thus reduce the delay time in accessing the main memory 140 and/or improve operations thereof.

In other words, the memory controller 130 according to some example embodiments may write or store the 56-byte data D and the 8-byte parity P in the main memory 140 by transmitting the single write command, rather than separately transmitting the data write command and the parity write command to the main memory 140. Therefore, the memory controller 130 may reduce the delay time in accessing the main memory 140 and/or improve operations thereof.

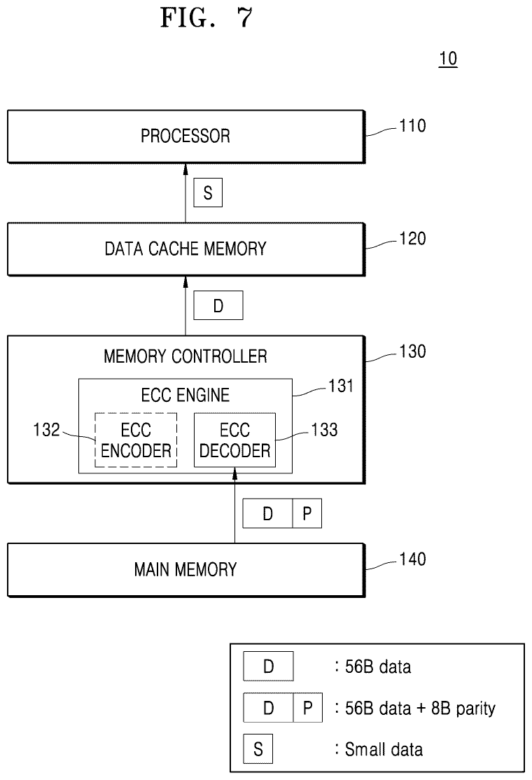

FIG. 7 is a block diagram illustrating the computing device 10 performing a read operation, according to some example embodiments. In the following descriptions, repeated descriptions as those given with reference to FIG. 2 are omitted.

Referring to FIG. 7, when the processor 110 makes a read request, the memory controller 130 may transmit a read command to the main memory 140. In response to the read command, the main memory 140 may read the 56-byte data D and the 8-byte parity all together, which are stored in one block. In other words, since the memory controller 130 may receive the 56-byte data D and the 8-byte parity P all together from the main memory 140 by using a single read command, the delay time in accessing the main memory 140 may be reduced. The ECC decoder 133 of the memory controller 130 may detect or correct errors in the received 56-byte data D. For example, the ECC decoder 133 may detect an error in the 56-byte data D on the basis of the 8-byte parity P and provide only the error-corrected 56-byte data D to the data cache memory 120. The data cache memory 120 may convert the received error-corrected 56-byte data D and provide the 8-byte small data S to the processor 110.

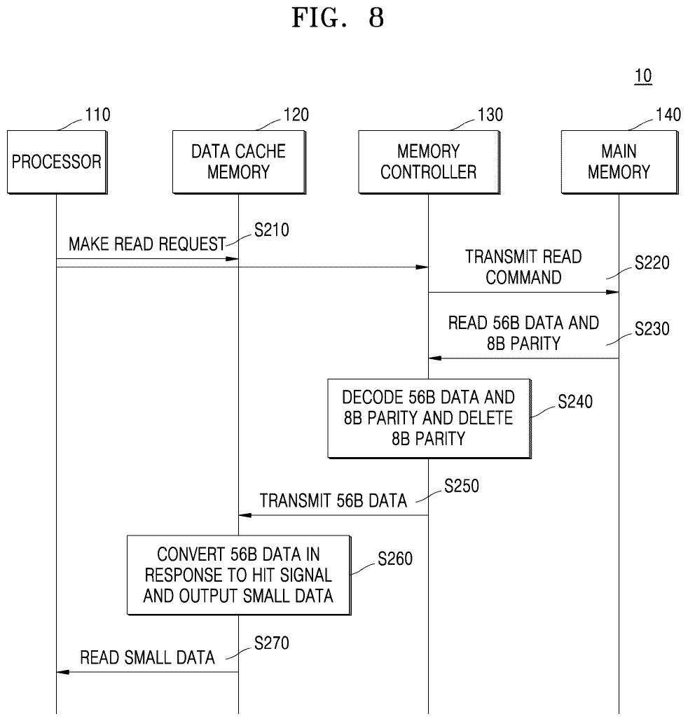

FIG. 8 is a flowchart illustrating an operation method of the computing device 10 performing a read operation, according to some example embodiments.

Referring to FIGS. 7 and 8 together, the processor 110 performs an operation of reading the 56-byte data from the main memory 140 using the data cache memory 120 and the memory controller 130.

Referring to FIG. 8, the processor 110 may request the data cache memory 120 and/or the main memory 140 to perform a read operation (S210).

The memory controller 130 may transmit a read command to the main memory 140 (S220). In response to the read command, the main memory 140 may read the 56-byte data D and the 8-byte parity P all together and transmit the 56-byte data D and the 8-byte parity P to the memory controller 130 (S230).

For example, the main memory 140 according to some example embodiments may store the 56-byte data D and the 8-byte parity P in one block. Also, the memory controller 130 may transmit a single read command to the main memory 140, rather than separately transmitting a data read command and a parity read command. Accordingly, the memory controller 130 may reduce the time to access the main memory 140.

The memory controller 130 may decode the received 56-byte data D and 8-byte parity P and delete the 8-byte parity (S240). For example, the ECC decoder 133 may detect an error in the 56-byte data D on the basis of the received 8-byte parity P. The memory controller 130 may transmit only the error-corrected 56-byte data D to the data cache memory 120 (S250). For example, the data cache memory 120 may include a plurality of cache lines, and each of the plurality of cache lines may be 56 bytes in size.

In response to a hit signal Hit, the data cache memory 120 may convert the 56-byte data D into the small data S and output the converted small data S (S260). For example, the data cache memory 120 may transmit the converted small data S to the processor 110.

The processor 110 may read the small data S that is transmitted from the data cache memory 120 (S270).

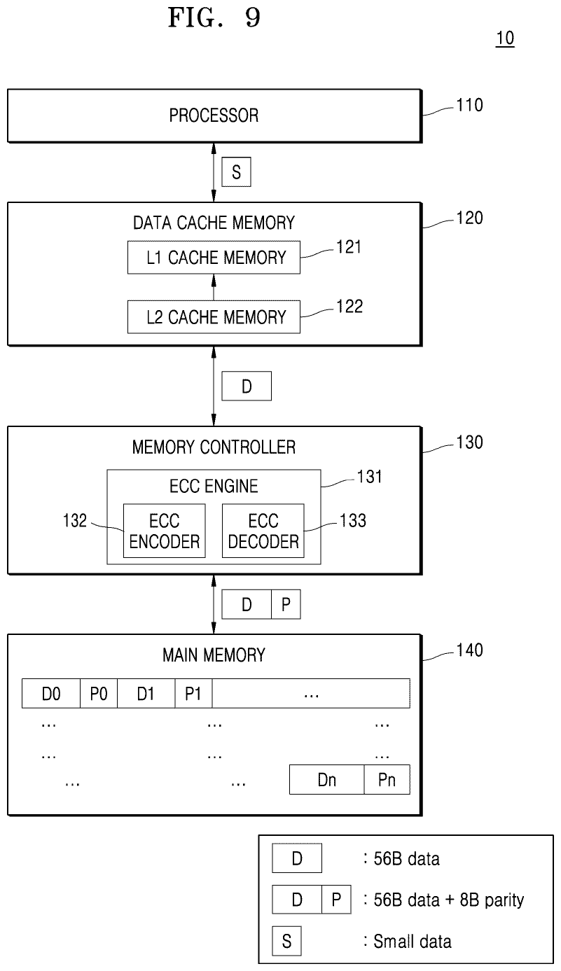

FIG. 9 is a block diagram illustrating a computing device 10 according to some example embodiments. In the following descriptions, repeated descriptions as those given with reference to FIGS. 1 and 2 are omitted.

Referring to FIG. 9, the computing device 10 may further include a processor 110, data cache memory 120, a memory controller 130, and main memory 140.

Referring to FIG. 9, the data cache memory 120 may include at least two pieces of cache memory, unlike FIGS. 1 and 2. However, some or all of the features of FIG. 9 may be present and/or included in FIGS. 1 and/or 2.

The data cache memory 120 may include first cache memory 121 and second cache memory 122. The first cache memory 121 may be relatively faster than the second cache memory 122, but may have a smaller capacity. The second cache memory 122 may be relatively slower than the first cache memory 121, but may have a larger capacity.

For example, the first cache memory 121 may correspond to the data cache memory 120 shown in FIG. 4, and the second cache memory 122 may simply store the 56-byte data.

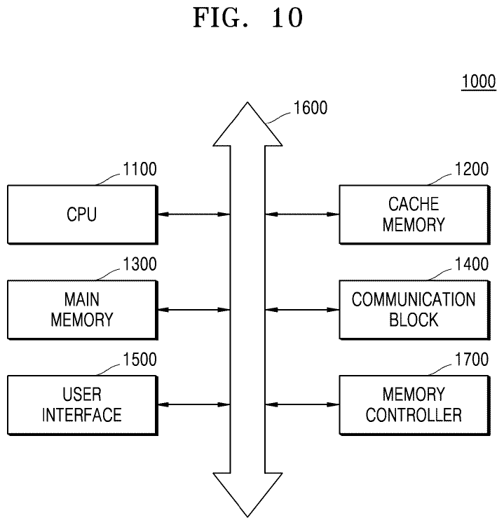

FIG. 10 is a block diagram illustrating an example configuration of an electronic system 1000, according to some example embodiments.

Referring to FIG. 10, the electronic system 1000 may include a central processing unit 1100, cache memory 1200, main memory 1300, a communication block 1400, a user interface 1500, and a memory controller 1700, which are electrically connected to a system bus 1600. For example, the electronic system 1000 may include one of the electronic devices, such as a desktop computer, a laptop computer, a tablet computer, a smartphone, a wearable device, a video game device, a work station, a server, and/or an electric vehicle.

According to some example embodiments, the electronic system 1000 may be provided as an application processor (AP). The AP may be utilized as a mobile device when an SoC includes a memory controller. Also, the electronic system 1000 illustrated in FIG. 10 may be dedicated to a server. For example, the mobile device may include a personal digital assistant (PDA), a portable computer, a web tablet, a wireless phone, a mobile phone, a digital music player, a memory card, and/or the like.

The memory controller 1700 may correspond to the memory controller 130 described with reference to FIGS. 1 to 9. According to some example embodiments, when the central processing unit 1100 requests access to the main memory 1300, the memory controller 1700 provides commands, addresses, or the like to the main memory 1300. Accordingly, the memory controller 1700 may control the main memory 1300.

The electronic system 1000 according to some example embodiments may include any of the computing devices 10 described above with reference to FIGS. 1 to 9. For example, the electronic system 1000 may include the computing device 10 of FIGS. 1 to 9, but example embodiments are not limited thereto.

The central processing unit 1100 may control all operations of the electronic system 1000. The central processing unit 1100 may process various types of arithmetic calculations and/or logical calculations.

The cache memory 1200 may correspond to the data cache memory 120 shown in FIGS. 1 to 9. The cache memory 1200 according to some example embodiments may include a plurality of cache lines, and each of the plurality of cache lines may be 56 bytes in size. In addition, the cache memory 1200 may utilize an address conversion scheme and/or set associative mapping for the 56-byte data received from the memory controller 1700. For example, when the address conversion scheme and/or the set associative mapping are used, the delay time in accessing the cache memory 1200 may be reduced and/or improve operations thereof.

The main memory 1300 may correspond to the main memory 140 shown in FIGS. 1 to 9. The main memory 1300 according to some example embodiments may include a plurality of rows, and the plurality of rows may include a plurality of blocks. One block among the plurality of blocks may store 56-byte data and 8-byte parity. In other words, the main memory 1300 may store the 56-byte data and the 8-byte parity data all together, and thus, upon a write or read operation of the main memory 1300, the data and parity may be simultaneously (e.g., at a same time, or about a same time such that, for example, subsequent actions are not impacted by any difference in timing) written or read. Accordingly, the delay time in accessing the main memory 1300 may be reduced.

The communication block 1400 may communicate with external devices/systems of the electronic system 1000. For example, the communication block 1400 may support at least one of other wireless communication protocols, such as long term evolution (LTE), worldwide interoperability for microwave access (WIMAX), global system for mobile communications (GSM), code division multiple access (CDMA), Bluetooth, near field communication (NFC), wireless fidelity (Wi-Fi), and a radio frequency identification (RFID), and/or at least one of other wired communication protocols, such as a transfer control protocol/internet protocol (TCP/IP), a universal serial bus (USB), and Firewire.

The user interface 1500 may mediate communication between the user and the electronic system 1000. For example, the user interface 1500 may include input interfaces, such as a keyboard, a mouse, a keypad, buttons, a touch panel, a touch screen, a touch pad, a touch ball, a camera, a microphone, a gyroscope sensor, and/or a vibration sensor. For example, the user interface 1500 may include output interfaces, such as a liquid crystal display (LCD) device, a light-emitting diode (LED) display device, an organic LED (OLED) display device, an active matrix OLED (AMOLED) display device, a speaker, a motor, and/or the like.

The user interface 1500 may include an interface for transmitting data to or receiving data from a communication network. The user interface 1500 may be in a wired or wireless form and may include an antenna, a wired or wireless transceiver, and/or the like. The data provided via the user interface 1500 or the communication block 1400 or processed by the central processing unit 1100 may be stored in the main memory 1300.

The system bus 1600 may provide communication paths between the components of the electronic system 1000. The components of the electronic system 1000 may exchange data with each other on the basis of bus formats of the system bus 1600. For example, the bus formats may include one or more of other interface protocols, such as USB, small computer system interface (SCSI), peripheral component interconnect express (PCIe), mobile PCIe (M-PCIe), advanced technology attachment (ATA), parallel ATA (PATA), serial ATA (SATA), serial attached SCSI (SAS), integrated drive electronics (IDE), enhanced IDE (EIDE), nonvolatile memory Express (NVMe), and universal flash storage (UFS).

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

While the inventive concepts have been particularly shown and described with reference to example embodiments thereof, it will be understood that various changes in form and details may be made therein without departing from the spirit and scope of the following claims.

What is claimed is:

1. A system on chip (SoC) configured to control an external main memory, the SoC comprising:
a memory controller configured to
generate B-byte parity for A-byte data and detect an error in the A-byte data using the B-byte parity, wherein A and B are natural numbers;
store the A-byte data and the B-byte parity to one memory block of the external main memory by transmitting a write command to the external main memory and the A-byte data and the B-byte parity to the external main memory; and
read the A-byte data and the B-byte parity from the one memory block of the external main memory by transmitting a read command to the external main memory;
a data cache memory configured to transmit the A-byte data to and receive the A-byte data from the memory controller and cache the A-byte data; and
a processor configured to access the external main memory.

2. The SoC of claim 1, wherein the external main memory comprises dynamic random-access memory (DRAM).

3. The SoC of claim 1, wherein the external main memory comprises a plurality of memory blocks, and each of the plurality of memory blocks is configured to store both the A-byte data and the B-byte parity.

4. The SoC of claim 3, wherein the external main memory has (A+B) bytes of a bandwidth to store the A-byte data and the B-byte parity together.

5. The SoC of claim 1, wherein the memory controller further comprises an error correction code (ECC) engine, and the ECC engine comprises:
an ECC encoder configured to generate the B-byte parity by encoding the A-byte data; and
an ECC decoder configured to detect an error in the A-byte data by using the B-byte parity.

6. The SoC of claim 1, wherein the data cache memory further comprises first level cache memory and second level cache memory that is slower than the first level cache memory.

7. The SoC of claim 1, wherein the data cache memory comprises a plurality of cache lines, and each of the plurality of cache lines is A bytes in size.

8. The SoC of claim 1, wherein
the memory controller is configured to use an address conversion scheme of transmitting the A-byte data to and receiving the A-byte data from the data cache memory,
the address conversion scheme is configured to convert a virtual address to a physical address,
the virtual address comprises a page offset field and a virtual page number field, and
the physical address comprises an offset field, an index field, and a tag field.

9. The SoC of claim 8, wherein the address conversion scheme comprises:
a translation lookaside buffer (TLB) configured to convert the virtual page number field to the tag field; and
an index/offset generator configured to convert the page offset field to the index field and the tag field.

10. The SoC of claim 1, wherein
the data cache memory and the processor are configured to transmit and receive small data from the A-byte data, and
the small data has a smaller size than the A-byte data.

11. The SoC of claim 1, wherein, based on the processor making a write request to the external main memory,
the data cache memory is configured to provide the A-byte data to the memory controller,
the memory controller is configured to generate the B-byte parity for checking the A-byte data for an error, and
the external main memory is configured to write the A-byte data and the B-byte parity together in one block.

12. The SoC of claim 1, wherein, based on the processor making a read request to the external main memory,
the external main memory is configured to transmit the A-byte data and the B-byte parity together to the memory controller, and
the memory controller is configured to perform decoding based on the B-byte parity and provides the A-byte data with the error corrected to the data cache memory.

13. A system on chip (SoC), the SoC comprising:
a memory controller configured to
control a main memory, the main memory comprising a plurality of blocks, and each of the plurality of blocks configured to store A-byte data and B-byte parity together, wherein A and B are natural numbers, and
generate the B-byte parity and detect, based on the B-byte parity, an error in the A-byte data; and
a data cache memory comprising a plurality of cache lines, and each of the plurality of cache lines is A bytes in size, and configured to transmit the A-byte data to and receive the A-byte data from the memory controller and cache the A-byte data.

14. The SoC of claim 13, further comprising a processor configured to access the main memory,
wherein the data cache memory and the processor exchange small data from the A-byte data, and the small data has a smaller size than the A-byte data.

15. The SoC of claim 14, wherein, based on the processor making a write request to the main memory,
the data cache memory is configured to provide the A-byte data to the memory controller,
the memory controller is configured to generate the B-byte parity for checking the A-byte data for an error, and
the main memory is configured to write the A-byte data and the B-byte parity together in one block.

16. The SoC of claim 14, wherein, based on the processor making a read request to the main memory,
the main memory is configured to transmit the a-byte data and the B-byte parity together to the memory controller, and
the memory controller is configured to detect an error in the A-byte data and provide the A-byte data with the error corrected to the data cache memory.

17. The SoC of claim 13, wherein
the memory controller is configured to use an address conversion scheme of transmitting the A-byte data to and receiving the A-byte data from the data cache memory,
the address conversion scheme is configured to convert a virtual address to a physical address,
the virtual address comprises a page offset field and a virtual page number field, and
the physical address comprises an offset field, an index field, and a tag field.

18. A computing device comprising:
a main memory, the main memory comprises a plurality of blocks, and each of the plurality of blocks stores A-byte data and B-byte parity together, and
a system on chip (SoC), the SoC comprising
a memory controller configured to generate the B-byte parity for detecting an error in the A-byte data and detect, based on the B-byte parity, the error in the A-byte data;
a data cache memory comprising a plurality of cache lines, and each of the plurality of cache lines is A bytes in size, and configured to cache the A-byte data from the memory controller; and
a processor configured to access the main memory.

19. The computing device of claim 18, wherein
A is 56, B is 8, and A is not a power of 2, and
based on the processor making a write request to the main memory,
the data cache memory is configured to provide the A-byte data to the memory controller,
the memory controller is configured to generate the B-byte parity for checking the A-byte data for an error, and
the main memory is configured to write the A-byte data and the B-byte parity together in one block, and
based on the processor making a read request to the main memory,
the main memory is configured to transmit the A-byte data and the B-byte parity together to the memory controller, and
the memory controller is configured to perform decoding and provide only the A-byte data to the data cache memory.

20. The computing device of claim 19, wherein
the memory controller is configured to use an address conversion scheme of transmitting the A-byte data to and receiving the A-byte data from the data cache memory,
the address conversion scheme is configured to convert a virtual address to a physical address,
the virtual address comprises a page offset field and a virtual page number field, and
the physical address comprises an offset field, an index field, and a tag field, and
the address conversion scheme comprises
a translation lookaside buffer (TLB) configured to convert the virtual page number field to the tag field; and
an index/offset generator configured to convert the page offset field to the index field and the tag field.
